(19) United States
(12) Patent Application Publication
(10) Pub. No.: US 2014/0006228 A1
(43) Pub. Date: Jan. 2, 2014

(54) E-Commerce Data Management and Software Application

(71) Applicant: ClaraStream LLC, Chicago, IL (US)

(72) Inventor: Matthew Tortora, Chicago, IL (US)

(73) Assignee: Matthew Tortora, Chicago, IL (US)

(21) Appl. No.: 13/917,903

(22) Filed: Jun. 14, 2013

Related U.S. Application Data
(60) Provisional application No. 61/659,639, filed on Jun. 14, 2012.

(51) Int. Cl. G06Q 10/08

(52) U.S. Cl. CPC G06Q 10/087
USPC 705/28

(57) ABSTRACT

The e-commerce product and data management software application of the first preferred embodiment is a method and system for categorizing products and data, entering data and or product information, and reformatting that data and or product information for upload and or import to an e-commerce website, e-commerce software platform, ERP system, or database for the purpose of displaying products and or product information on the user's e-commerce website, or storing product data in a user's e-commerce software platform, ERP system, or database.

### BRIEF DESCRIPTION OF THE FIGURES

FIG. 1 is a schematic representation of the single page interface containing an image of the product and data entry fields.

FIG. 2 is a schematic representation of the single page interface containing predetermined product information and data entry fields.

FIG. 3 is a schematic representation of the single page interface containing an image of the product, predetermined product information, text entry fields, and the product name field.

FIG. 4 is a schematic representation of the single page interface containing an image of the product, predetermined product information, and category selection fields in the form of either multi-select boxes, drop down boxes, or text lookup fields.

FIG. 5 is a schematic representation of the single page interface containing an image of the product, predetermined product information, category selection fields in the form of either multi-select boxes, drop down boxes, or text lookup fields, text entry fields, and a list of editable products or a text lookup field of editable products.

FIG. 6 is a schematic representation of the single page interface containing a link to a pop up box or expandable window with a product image and/or predetermined product information, and data entry fields.

FIG. 7 is a schematic representation of the algorithm and rules system for assigning products to categories.

FIG. 8 is a schematic representation of the algorithm and rules system for assigning products to categories.

FIG. 9 is a schematic representation of the feature whereby a user can select a group of products and assign those products to specific categories and or attributes.

FIG. 10 is a schematic representation of the product naming algorithm.

FIG. 11 is a second schematic representation of the product naming algorithm.

FIG. 12 is a schematic representation of the process of reformatting data and importing the reformatted data into a user's e-commerce website, or e-commerce software, via an application programming interface.

FIG. 13 is a schematic representation of the process of reformatting data and importing the reformatted data into a user's ERP system or database via an application programming interface.

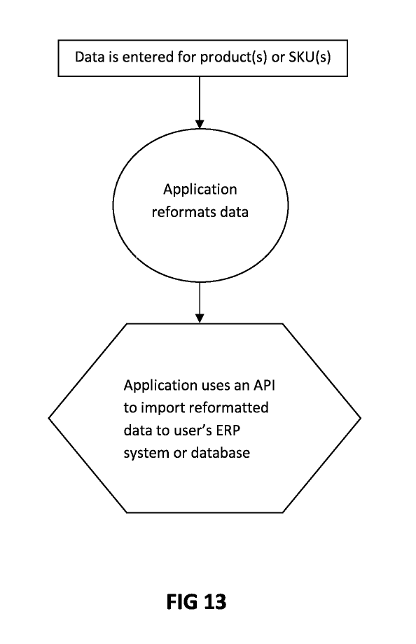

FIG. 14 is a schematic representation of the algorithm and process for automatically assigning prices to products.

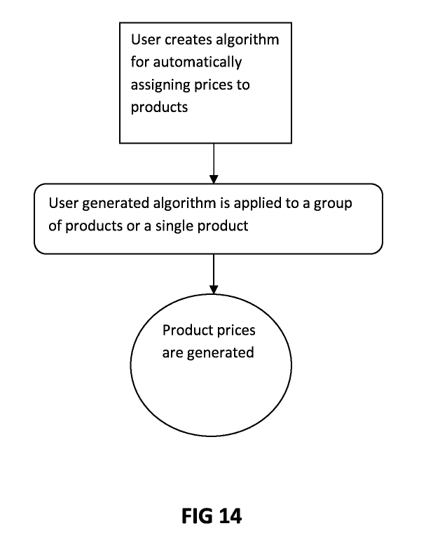

FIG. 15 is a schematic representation of a breakdown of predetermined product information which is displayed on the single page interface.

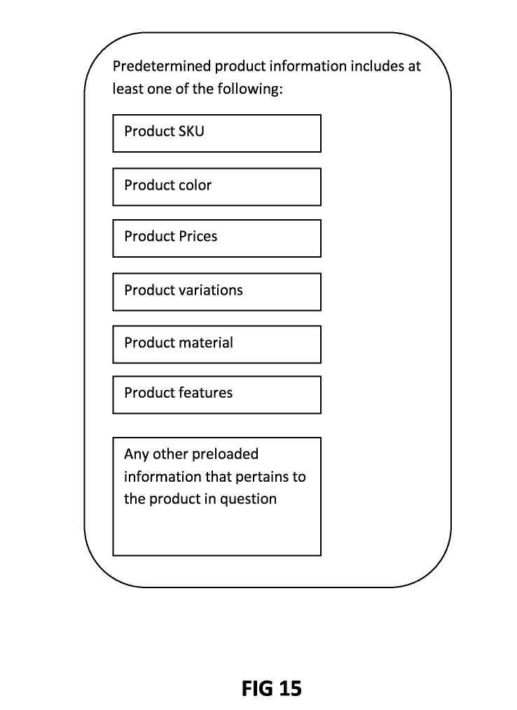

FIG. 16 is a schematic representation of the data-flow of product information within the software application from a basic file to the user's e-commerce website.

FIG. 17 is a schematics representation of the data-flow of product information within the software application from a single platform and central repository to multiple e-commerce websites.

### DESCRIPTION OF THE PREFERRED EMBODIMENTS

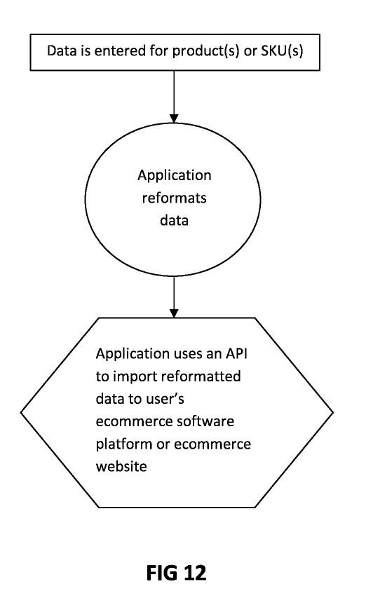

The e-commerce product and data management software application of the first preferred embodiment is a method and system for categorizing products and data, entering data and/or product information, and reformatting that data and/or product information for upload and/or import to an e-commerce website, e-commerce software platform, ERP system, or database for the purpose of displaying products and/or product information on the user's e-commerce website, or storing product data in a user's e-commerce software platform, ERP system, or database as shown in FIG. 12. The e-commerce product and data management software application can be used in conjunction with any e-commerce software platform, e-commerce website, ERP system, or database.

The user will create a template with categories, attributes, and data fields that correlates with the categories, attributes, and data fields on the user's e-commerce website, e-commerce software, ERP system, or database for the purpose of data entry and data creation pertaining to products. Products and attributes may include but are not limited to (delete semi-colon) prices, variations, features, styles, colors, materials, or any other category or attribute the user feels is necessary.

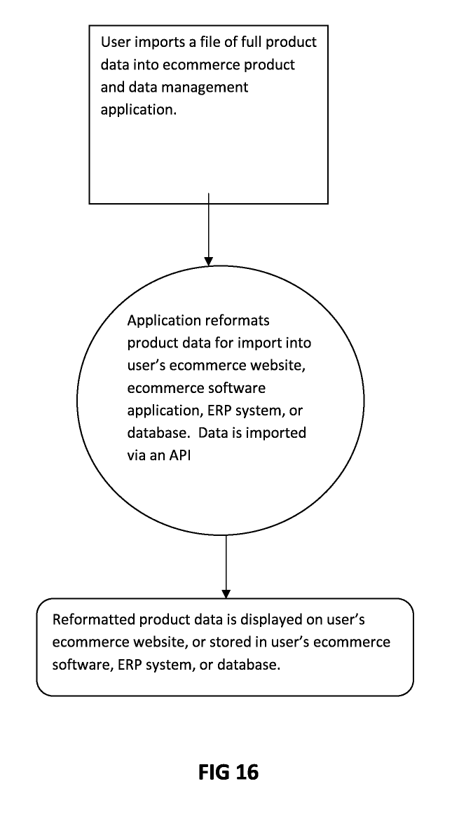

The e-commerce product and data management software application reformats the data that the user enters or initially imports from a pre-existing file to meet the data format and or data arrangement requirements of the software or website that the user will be importing or uploading to. The e-commerce product and data management software application will automatically reformat all necessary and pertinent product data including but not limited to; price, cost, colors, features, categories, materials, related products, variations, descriptions, images, product name, URL for the page product is to be displayed on, stock status, delivery information, any other information or fields that user feels are necessary or that the user's e-commerce website, e-commerce software platform, ERP system, or database requires for successful import and/or display on the user's e-commerce website. All reformatted data can be directly imported into the user's e-commerce site, e-commerce software, ERP system, or database via an application programming interface as shown in FIG. 12. The user may also export all reformatted data in the file format of their choice. File formats may include but not be limited to; html, csv, or text files. The exported file will include all the data which the user entered or imported into the e-commerce product and data management software application and the data will be arranged, formatted, and displayed in a format that the user specifies or that the user's e-commerce website, e-commerce software platform, ERP system, or database requires for successful import and or display of products and product information. As an alternative the user may import all product information into the e-commerce product and data management software application for the purposes of reformatting the data and therefore completely bypassing the data entry phase provided by the single page interface as shown in FIG. 16. If the user chooses this option the e-commerce product and data management software application will automatically reformat all pertinent product data including but not limited to; price, cost, colors, features, categories, materials, related products, variations, descriptions, images, product name, URL for page product is to be displayed on, stock status, delivery information, any other information or fields that user feels are necessary. The imported and reformatted data will include all the data which the user imported into the e-commerce product and data management software application and the data will be arranged, formatted, and displayed in a format that the user specifies or that the user's e-commerce website, e-commerce software platform, ERP system, or database requires for successful import. From here the user may either directly import the data into their e-commerce website, e-commerce software platform, ERP system, or database via an application programming interface or export the data into a file format of their choice including but not limited to html, csv, or text file.

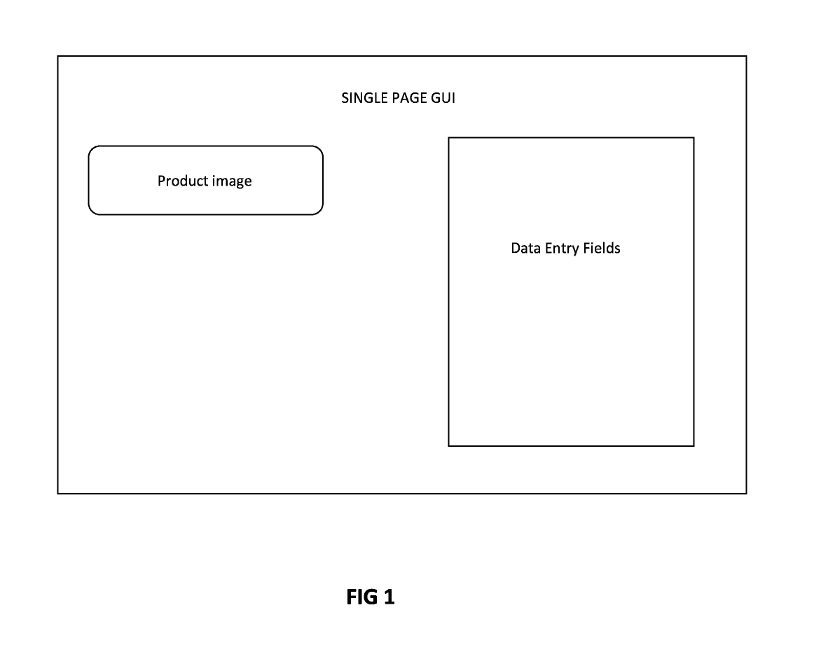

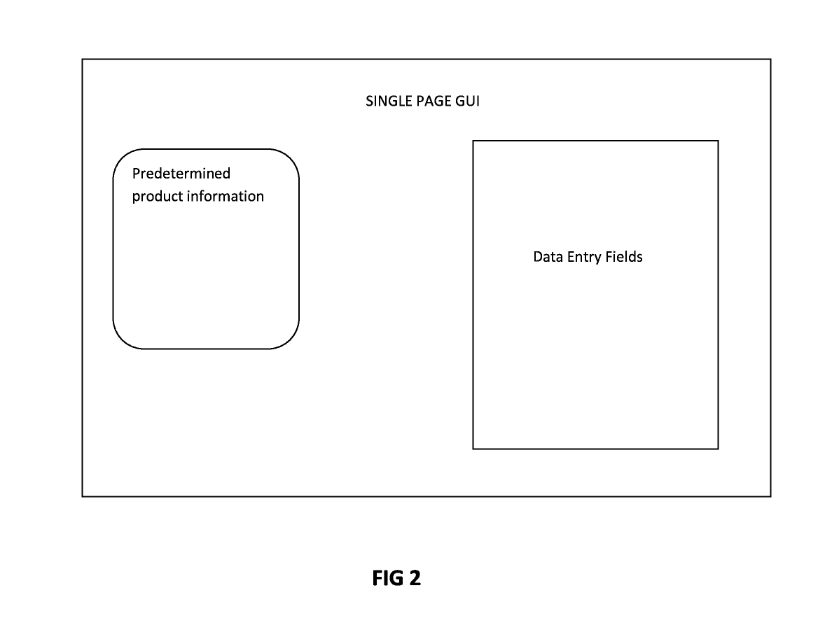

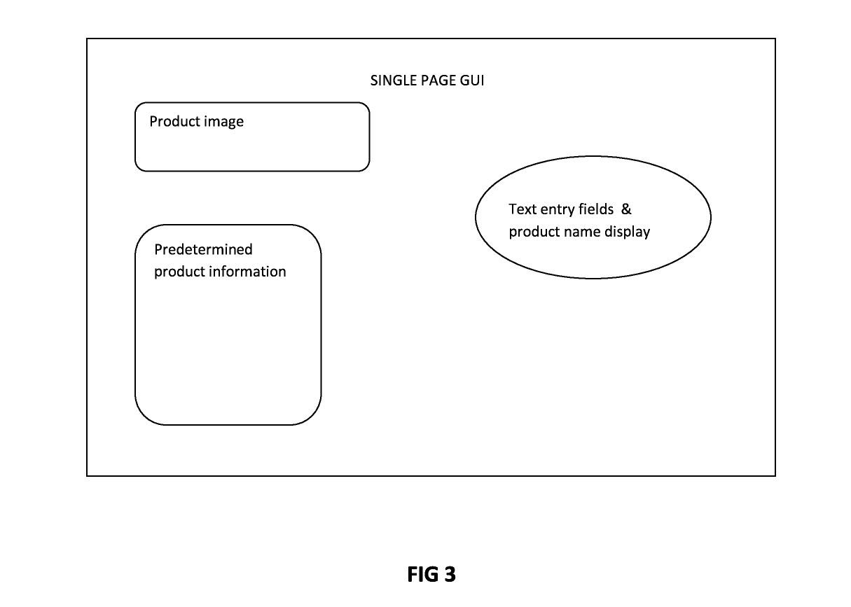

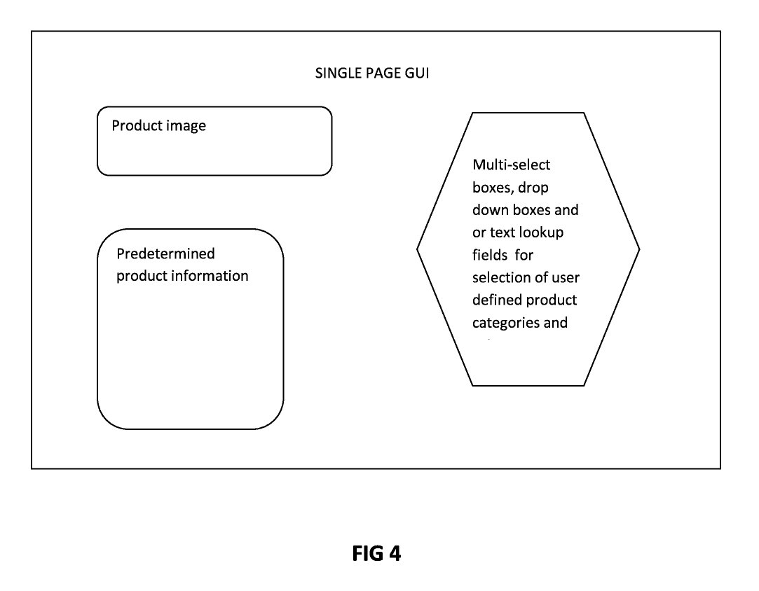

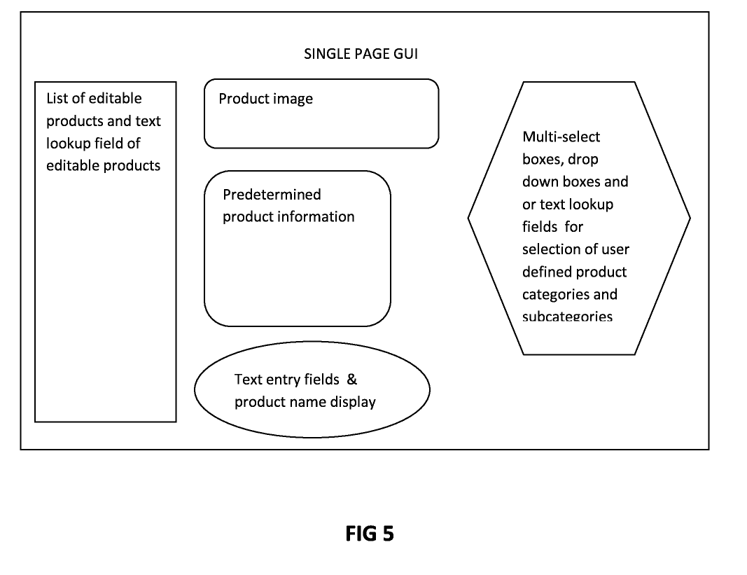

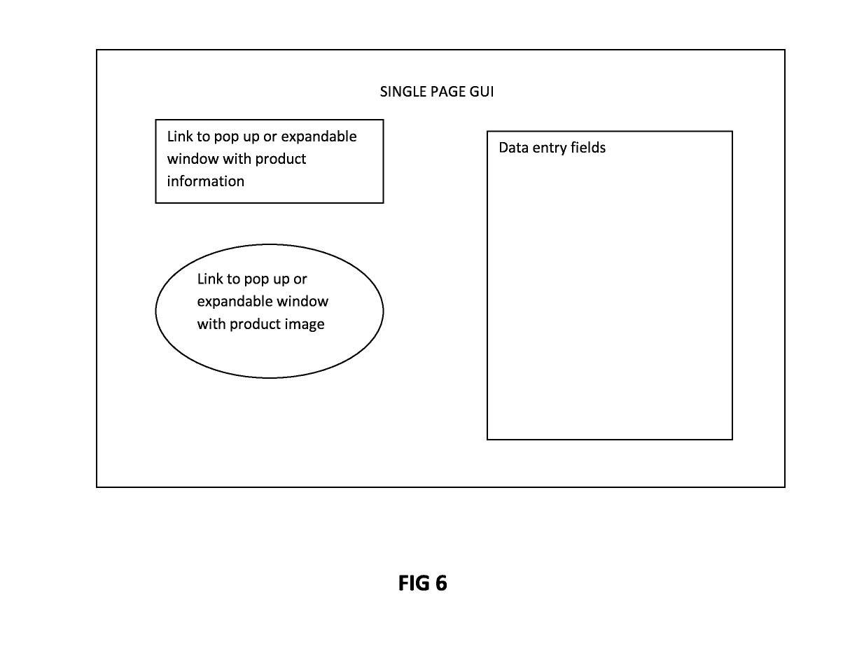

To enter data the e-commerce product and data management software application uses a single page interface where users enter data points pertaining to a specific product. Data points may include but are not limited to; price, cost, colors, features, categories, materials, related products, variations, descriptions, images, product name, URL for page product is to be displayed on, stock status, delivery information, any other information or fields that user feels are necessary. Predetermined and/or imported data points pertaining to a given product are displayed on this single page interface as shown in FIG. 1. The single page interface displays preloaded and or predetermined product information that the user imports and or an image of the product as shown in FIGS. 1 and 2. The single page interface will display text entry fields where users will enter data pertaining but not limited to; price, cost, colors, features, categories, materials, related products, variations, descriptions, images, product name, URL for page product is to be displayed on, stock status, delivery information, any other information or fields that user feels are necessary as shown in FIGS. 3 and 5. The single page interface will display product categorization fields in the form of multi-select boxes and or drop down boxes with user defined or user imported categories and subcategories including but not limited to; color, size, style, material, brand, price, features, or any other category or attribute that user feels is necessary. From these fields the user will select and assign the product to specific categories as shown in FIGS. 4 and 5. The single page interface will display a list of available products which can be edited. Users can access products for edit via this list which is in the form of a scrolling list or search for a specific product via a text lookup field to access a product as shown in FIG. 5. As an alternative to entering all information pertaining to a product on the single page interface the e-commerce product and data management software application uses a single page interface where users enter only one data point, or select one category or attribute pertaining to a product (i.e. price, color, style, specific category etc. . . . ). In this scenario the interface will only display the data point or category field that the user will be entering data for. Once the user finishes entering a specific data point or selecting a specific category or attribute for a particular group of products the user will repeat this process and enter a new data point for the same group of products using the single page interface. This process will repeat itself until all applicable data points and categories have been entered for a designated group of products. As an alternative to the display of a product image or predetermined product information on the single page interface, the interface can also provide a link to a pop up box, or expandable window where product information including but not limited to; prices, colors, variations, features, materials, or any other predetermined or imported information that the user feels is necessary, and or a product image will be displayed for a given product as shown in FIG. 6. Once the user has completed entering all of the required information for a product on the single page interface the user will save their work by pressing a designated button and can move on to editing a new product. The user may access any saved product at a later time to re-edit that product and or change previously entered information. The user may decide what fields are or are not displayed on the single page interface. In conjunction with preloaded and or predetermined product information the single page interface can display: just text entry and product name fields as shown in FIG. 1.; just multi-select boxes, drop down boxes, or text lookup fields for category and or attribute selection as shown in FIG. 4, or all fields as shown in FIG. 5.

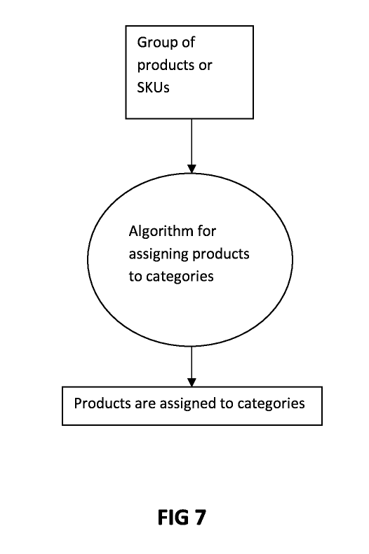

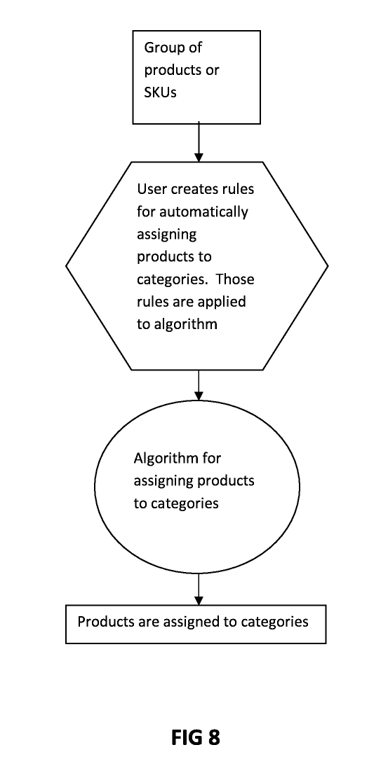

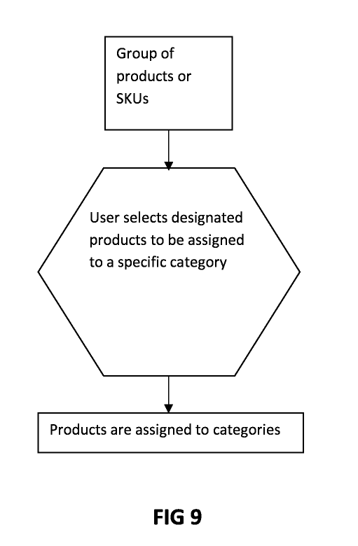

The e-commerce product and data management software application can use a rules based algorithm for assigning products to categories or tying attributes to products including but not limited to; color, size, style, material, brand, price, features, or any other category or attribute that user feels is necessary. The user will create rules whereby predetermined product information will correlate to a specific category or attribute (i.e. if product has “X” data point in predetermined information then product will be assigned to category or attribute “Y”) as shown in FIGS. 7 and 8. As an alternative to this the user may manually select or designate a group of products to be assigned to a specific category or categories and/or attributes. This manual selection process can be achieved via multi-select boxes, text entry fields, or the import of a file containing the designated list of products to be assigned to a specific category or attribute as shown in FIG. 9.

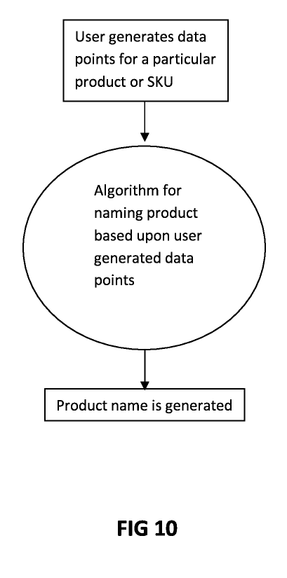

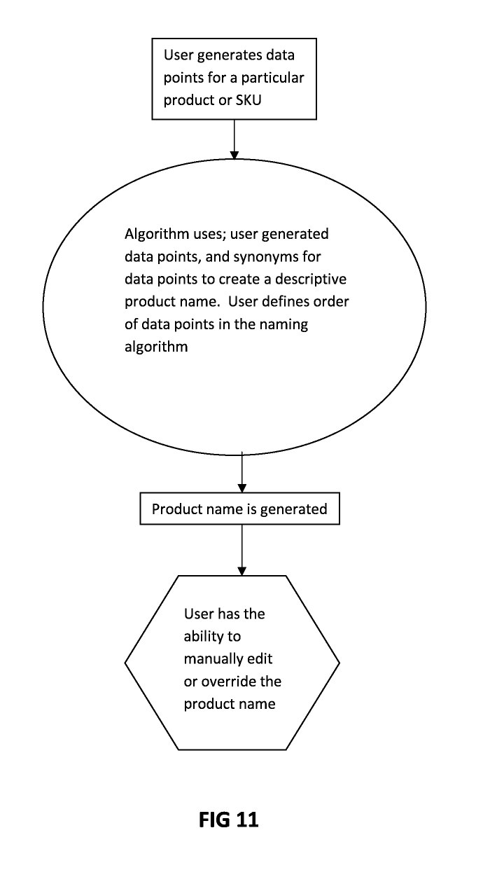

The e-commerce product and data management software application can use an algorithm for naming products as shown in FIG. 10. The algorithm will assign a name to a product based upon information the user enters on the single page interface via text entry fields, category selection fields, or pulling data from imported and predetermined product information. Fields may include but not be limited to; color, size, style, material, brand, price, features, or any other category or attribute that user feels is necessary. The user has the ability to decide what fields, categories, attributes, or predetermined information the algorithm uses when naming a product as shown in FIG. 11. The user has the ability to decide what order fields, categories, attributes, or predetermined information is displayed in when the algorithm names a product. The user may associate synonyms or words with certain fields, categories, attributes, or predetermined information that the algorithm may use as a replacement as shown in FIG. 11. The algorithm can present the user with several options for the product name on the single page interface and from those options that user will select a name. The algorithm will display a list of potential names on the single page interface and from that list the user will select a product name. The user has the ability to edit and or adjust a name the algorithm generates. The user has the ability to override this algorithm and manually name a product. The e-commerce product and data management software application will track the history of product names and alert the user if a duplicate name is entered. The user may completely turn off the product naming algorithm feature and manually name all products.

The e-commerce product and data management software application can set product prices based upon user generated rules. (i.e.; if product is “X” then price is “Y” or if product is “X” then price is “Y×1.5”).

The e-commerce product and data management software application has the ability to support any global currency or language.

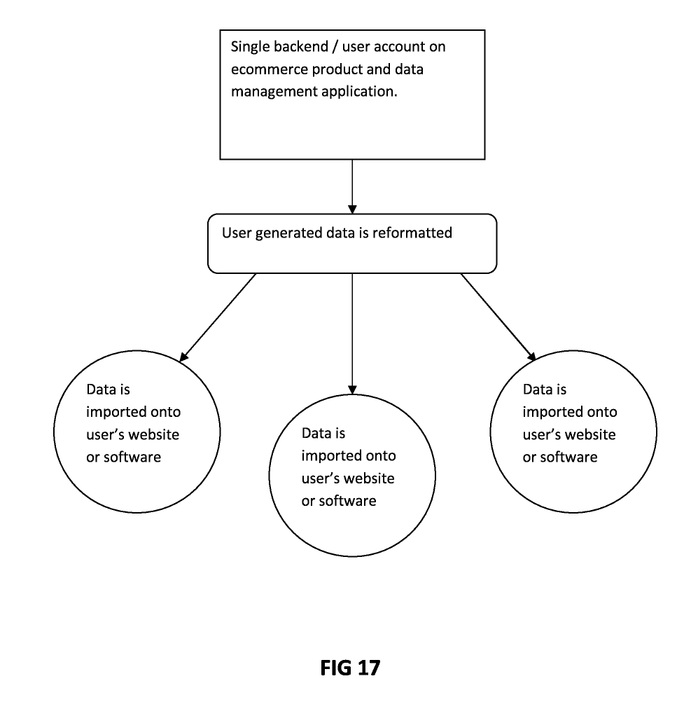

The e-commerce product and data management software application can support multiple-commerce websites, e-commerce software platforms, ERP systems, or databases for a single user/user account as shown in FIG. 17. When reformatting and exporting data the user may select which of these entities to export the data to.

1. A software application with an e-commerce data management component.
